(19) United States
(12) Patent Application Publication
(10) Pub. No.: US 2019/0347127 A1
(43) Pub. Date: Nov. 14, 2019

(54) SERVICE PROVISIONING AND ORCHESTRATION FOR VIRTUAL MACHINE TO CONTAINER MIGRATION

(71) Applicant: Red Hat, Inc., Raleigh, NC (US)

(72) Inventors: Stephen Coady, Waterford (IE); Leigh Griffin, Waterford City (IE)

(21) Appl. No.: 15/975,158

(22) Filed: May 9, 2018

(51) Int. Cl. G06F 9/48; H04L 12/24; G06F 11/34; G06F 9/455

(52) U.S. Cl. CPC G06F 9/4856; H04L 41/0806; G06F 11/3442; G06F 2009/45595; G06F 9/45558; G06F 2009/45562; G06F 2009/4557; G06F 11/3409

(57) ABSTRACT

Technology is disclosed for analyzing a virtual machine running multiple processes of services to provision and orchestrate the services within one or more containers. An example method may include: receiving data of a virtual machine, the data indicating a set of processes executed by the virtual machine; analyzing the set of processes to determine a set of candidate processes for building a plurality of container images; building the plurality of container images in view of the set of candidate processes and the data of the virtual machine; determining that computer code of a first process of the set of candidate processes is executable within a container supported by a first container image of the plurality of container images; and terminating the first process of the set of processes executed by the virtual machine.

### TECHNICAL FIELD

The present disclosure is generally related to migrating computing services from a hardware level virtualization platform using virtual machines to an operating system level virtualization platform using containers, and is more specifically related to analyzing a virtual machine running multiple processes of services to provision and orchestrate the services within one or more containers.

### BACKGROUND

Modern data centers may support different types of virtualization technology that can be used to consolidate the data center infrastructure and increase operational efficiencies. The virtualization technology may include hardware level virtualization, operating system level virtualization, other virtualization, or a combination thereof. The hardware level virtualization may involve a hypervisor (e.g., virtual machine monitor) that emulates portions of a physical system and manages one or more virtual machines. Each virtual machine may have its own guest operating system kernel that relies on features of a kernel of the hypervisor. In contrast, operating system level virtualization may include a single operating system kernel that manages multiple isolated virtual containers. Each virtual container may share the kernel of the underlying operating system without requiring its own kernel. Avoiding usage of separate kernels may reduce computational overhead. Data centers may therefore benefit by converting the services running on a virtual machine to run within one or more containers.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 depicts a high-level block diagram of an example distributed system, in accordance with one or more aspects of the present disclosure;

FIG. 2 depicts a block diagram of an example agent for inspecting a target machine (e.g., virtual machine or physical machine), in accordance with one or more aspects of the present disclosure;

FIG. 3 depicts a block diagram of an example computer system for building container image in view of data of a virtual machine, in accordance with one or more aspects of the present disclosure;

FIG. 4 depicts a flow diagram of an example method for converting services executed by a virtual machine to one or more container images, in accordance with one or more aspects of the present disclosure;

FIG. 5 depicts a flow diagram of an example method for determining readiness of services within a container to route service requests to the container, in accordance with one or more aspects of the present disclosure;

FIG. 6 depicts a flow diagram of an example method for converting services executed by a virtual machine to one or more container images and routing services to a container supported by the container images, in accordance with one or more aspects of the present disclosure;

FIG. 7 depicts a block diagram of an example apparatus in accordance with one or more aspects of the present disclosure;

FIG. 8 depicts a block diagram of an illustrative computing device operating in accordance with the examples of the present disclosure.

### DETAILED DESCRIPTION

Modern data centers provide services using a combination of physical machines and virtual machines. A single virtual machine may execute multiple processes in order to provide one or more services. Converting the services run by the virtual machine to be run within containers often involves the intervention of an IT administrator. The IT administrator may provide details about a guest operating system managing the services and identify which processes correspond to the services being converted to run in containers. The virtual machine may execute hundreds of processes, however, only a small subset of the processes may need to be converted to provide the services within a container. Some processes may be highly prioritized or deprioritized in terms of migration based on various business necessities or technology optimization considerations. Relying on an IT administrator to identify the processes that correspond to a service and to identify the dependencies of the processes may be an error prone and time-consuming task. The migration effort may be complex and costly, and lead to reduced service uptime, causing disruption to the end users of the services.

When migrating from virtual machines to containers, being able to maintain service immutability becomes a concern. Service immutability is that which is required to ensure that a particular service functions and behaves in the same manner regardless of where it is hosted or served from. Since the relationship between a service and a container is assumed to be a one to one relationship, a direct conversion of all services as a whole from virtual machines to containers is not viable as services within virtual machines do not usually have a one to one relationship. However, dividing the services in individual services is also challenging, especially the aspect of combining the individual services back together to represent the whole. Yet another problem is to determine when to route requests for services to the newly built containers as it requires the containers to be ready and functional to serve customers requests at an adequate level. Determining when to terminate the old virtual machine services and when to use the containers exclusively can pose challenges.

Aspects of the present disclosure address the above and other deficiencies by providing technology to convert services from executing on a virtual machine using hardware level virtualization to executing within containers using operating system level virtualization. In one example, the technology disclosed herein may involve receiving data indicating a set of processes executed by a virtual machine. The technology may analyze the set of processes in view of a plurality of rules. The rules may be used to filter the set of processes to determine a set of candidate processes for conversion of services from executing on the virtual machine to a container. For example, the set of processes may be associated with data common to the virtual machine's operating system and data specific to the one or more services. Indicated by the rules, the data common to the operating system may be filtered out and the subset of data specific to the services may be used to build the one or more container images. The set of candidate processes and the data from the virtual machine may be used to build a plurality of container images to support one or more containers.

The technology may then store the plurality of container images on a storage device accessible over a network. Once the container images are built and stored on the storage devices, the technology may analyze readiness of the container images to route service requests to a container supported by the container images. The technology may provide for a plurality of readiness factors that may be used to analyze the readiness of the container images stored on the storage device. In an example, the technology may determine that a first container image of the stored container images satisfies one or more of the readiness factors. The technology may then identify a first process of the set of processes executed by the virtual machine which is to be executed within a container supported by the first container image that satisfied one or more of the readiness factors. As it is determined that the first container is ready such that the first process can be executed within the first container, the first process may be terminated from within the virtual machine. The container may be instantiated using the first container image and the first process may be executed within the container.

The systems and methods described herein include technology that enhances the ability to convert services of a virtual machine to one or more container images that support operating system level virtualization. In particular, aspects of the present disclosure may enable multiple services executing on a virtual machine to be executing within one or more containers. The conversion process may receive input identifying one or more virtual machines and may iterate through each virtual machine and migrate the services of each virtual machine to corresponding containers. This may reduce input required by an IT administrator and enable automatic migration across virtualization platforms within a data center or across data centers. Aspects of the present disclosure may also reduce the computing resources consumed by the containerized services by optimizing the layering of the container images. The technology may determine the number of layers as well as the content of the layers in order to optimize the amount of content shared across layers of a container or across different containers. This may reduce the storage resources (e.g., disk and memory space), processing resources (e.g., processor cycles), Input Output (I/O) resources, other computing resources, or a combination thereof. The technology may provide guidance to the customers as to when the system is ready to migrate an individual service or all services of an entire virtual machine. The technology provides a mechanism for routing service requests to both virtual machines and containers, which makes redundancy possible for the time being it is necessary, and to have minimum to no downtime during migration.

Various aspects of the above referenced methods and systems are described in details herein below by way of examples, rather than by way of limitation. The examples provided below discuss a computing environment where the services are executed by virtual machines, but other examples may include services that are executed on physical machines that is absent virtual machines (e.g., absent hardware level virtualization). In which case, all instances of virtual machine may correspond to a target machine (e.g., physical target machine) and the services executing on the physical target machine may be containerized to run using operating system level virtualization.

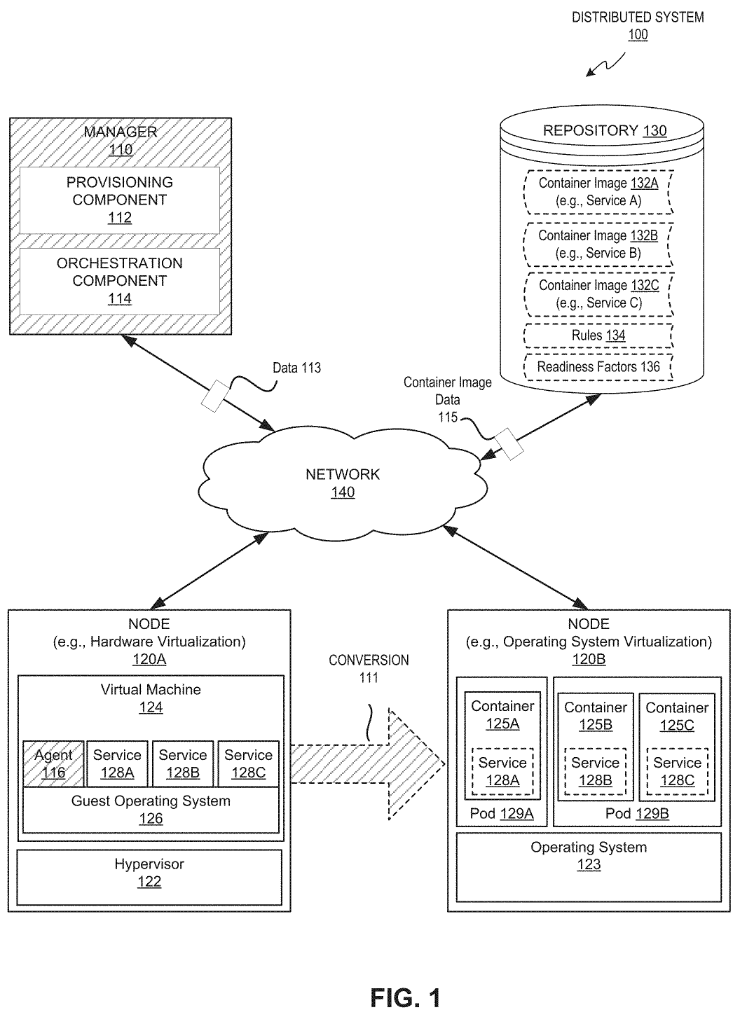

FIG. 1 illustrates an example distributed system 100 in which implementations of the disclosure may operate. The distributed system 100 may include a manager 110, a plurality of nodes 120A, 120B, and a repository 130 coupled via a network 140. Network 140 may be a public network (e.g., the internet), a private network (e.g., a local area network (LAN) or wide area network (WAN)), or a combination thereof. In one example, network 140 may include a wired or a wireless infrastructure, which may be provided by one or more wireless communications systems, such as a wireless fidelity (WiFi) hotspot connected with the network 140 and/or a wireless carrier system that can be implemented using various data processing equipment, communication towers, etc.

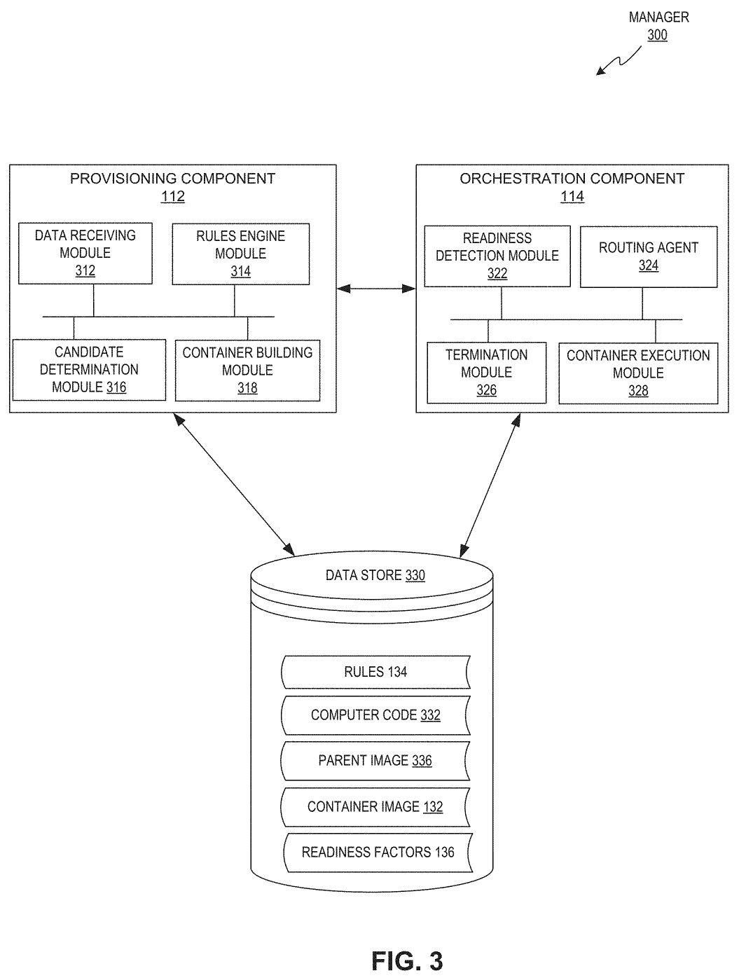

Manager 110 may be hosted by a computing device and may include one or more computer programs executed by the computing device for centralized management of distributed system 100. In one implementation, the manager 110 may comprise various interfaces, including administrative interface, reporting interface, and/or application programming interface (API) to communicate with nodes 120A-B, as well as to user portals, databases, directory servers and various other components, which are omitted from FIG. 1 for clarity. Manager 110 may interact with one or more computing devices to perform a conversion 111. Conversion 111 may be the same or similar to a containerization of one or more services (e.g., processes) running on a target machine (e.g., virtual machine or physical machine) to one or more container images that can be run using operating system level virtualization. In the example shown in FIG. 1, manager 110 may include a provisioning component 112 and an orchestration component 114. Provisioning component 112 may analyze data from a virtual machine. In one example, provisioning component 112 may receive data 113 (e.g., configuration data) from an agent 116 that has access to content of virtual machine 124. Provisioning component 112 may analyze data 113 to identify a set of processes executing on the virtual machine that provide one or more services, analyze the set of processes in view of a set of rules to determine a set of candidate processes for building container images, and build one or more container images (e.g., container image data 115) in view of the data 113 of the virtual machine 124. The one or more container images may collectively include one or more of the services executed by the virtual machine. Orchestration component 114 may ensure stability of client requests for various services. In one example, orchestration component 114 may analyze container images that have been built using the provisioning component 112 in view of a set of readiness factors, determine that a first container image satisfies at least one readiness factor, and identify a first process that can be executed within a container supported by the first container image to route service requests to the container. Orchestration component 114 may also terminate the first process from the virtual machine 124 and initiate execution of the first process within the container. The features of manager 110 are discussed in more detail in regards to FIG. 3.

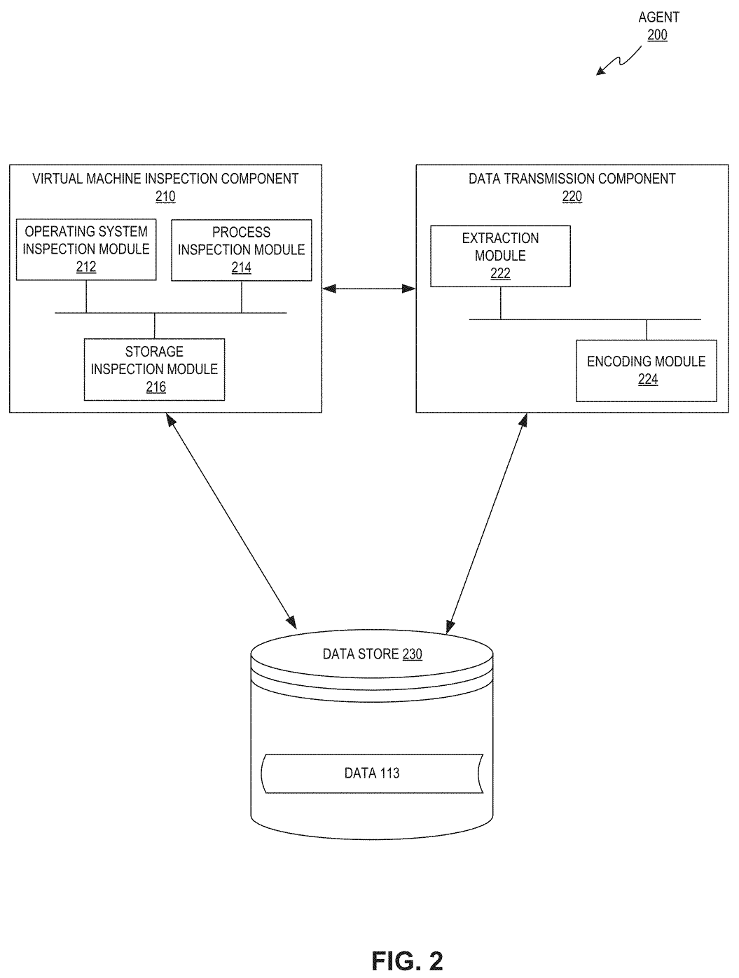

Agent 116 may be a computer program or program component that inspects the virtual machine and provides data about the virtual machine to manager 110. Agent 116 may execute as one or more user space processes, kernel processes, or a combination thereof on any node with access to executable content of the virtual machine. The node that executes agent 116 may be the same node that is executing the virtual machine (e.g., node 120A) or a different node. Agent 116 may be installed within or managed by a virtual machine, hypervisor 122, a host operating system, a guest operating system, other computer program, or a combination thereof. The features of agent 116 are discussed in more detail in regards to FIG. 2. In the example shown in FIG. 1, agent 116 may execute as one or more processes within virtual machine 124 and may transmit data of virtual machine 124 to manager 110 via node 120A.

Nodes 120A-B may comprise one or more computing devices with one or more processors communicatively coupled to memory devices and input/output (I/O) devices. Although nodes 120A-B comprise a computing device, the term “node” may refer to a computing device (e.g., physical machine), a virtual machine, or a combination thereof. Each of the nodes 120A-B may provide one or more levels of virtualization such as hardware level virtualization, operating system level virtualization, other virtualization, or a combination thereof. The hardware level virtualization may involve a hypervisor (e.g., virtual machine monitor) that emulates portions of a physical system and manages one or more virtual machines. In contrast, operating system level virtualization may include a single operating system kernel that manages multiple isolated virtual containers. Each virtual container may share the kernel of the underlying operating system without requiring its own kernel.

Node 120A may provide hardware level virtualization by running a hypervisor 122 that provides hardware resources to one or more virtual machines 124. Hypervisor 122 may be any program or combination of programs and may run directly on the hardware (e.g., bare-metal hypervisor) or may run on or within a host operating system (not shown). The hypervisor may manage and monitor various aspects of the operations of the computing device, including the storage, memory, and network interfaces. The hypervisor may abstract the physical layer features such as processors, memory, and I/O devices, and present this abstraction as virtual devices to a virtual machine 124 executing a guest operating system 126.

Guest operating system 126 may be any program or combination of programs that are capable of managing computing resources of virtual machine 124 and/or node 120A. Guest operating system 126 may include a kernel comprising one or more kernel space programs (e.g., memory driver, network driver, filesystem driver) for interacting with virtual hardware devices or actual hardware devices. In one example, guest operating system 126 may include Linux®, Solaris®, Microsoft Windows®, Apple Mac®, other operating system, or a combination thereof. Guest operating system 126 may manage the execution of multiple processes to provide services 128A-C.

Service 128A-C may be any computing services that can receive, transmit, or process requests and perform one or more computing tasks in view of the requests. Each service may include one or more processes that are executed on node 120A and each of the processes may function as a client process, a server process, or a combination thereof. The processes may execute on a single virtual machine or spread across multiple machines. In one example, services 128A-C may include one or more web services, database services, filesystem services, networking services, messaging services, load balancing services, clustering services, configuration management services, other services, or a combination thereof.

Node 120B may provide operating system level virtualization by running a computer program that provides computing resources to one or more containers 125A-C. Operating system level virtualization may be implemented within the kernel of operating system 123 and may enable the existence of multiple isolated containers. In one example, operating system level virtualization may not require hardware support and may impose little to no overhead because programs within each of the containers may use the system calls of the same underlying operating system 123. This may enable node 120B to provide virtualization without the need to provide hardware emulation or be run in an intermediate virtual machine as may occur with hardware level virtualization. Operating system level virtualization may provide resource management features that isolate or limit the impact of one container (e.g., container 125A) on the resources of another container (e.g., container 125B or 125C).

The operating system level virtualization may provide a pool of computing resources that are accessible by container 125A and are isolated from one or more other containers (e.g., container 125B). The pool of resources may include filesystem resources (e.g., particular volumes), network resources (e.g., particular network interfaces, sockets, addresses, or ports), memory resources (e.g., particular memory portions), other computing resources, or a combination thereof. The operating system level virtualization may also limit (e.g., isolate) a container's access to one or more computing resources by monitoring the containers activity and restricting the activity in view of one or more limits. The limits may restrict the rate of the activity, the aggregate amount of the activity, or a combination thereof. The limits may include one or more of filesystem limits, disk limits, input/out (I/O) limits, memory limits, CPU limits, network limits, other limits, or a combination thereof.

Operating system 123 may include an operating system virtualizer that may provide containers 125A-C with access to computing resources. The operating system virtualizer may wrap one or more processes (e.g., of a particular service) in a complete filesystem that contains the code, runtime, system tools, system libraries, and other data present on the node that can be used by the processes executing within the container. In one example, the operating system virtualizer may be the same or similar to Docker® for Linux® or Windows®, ThinApp® by VMWare®, Solaris Zones® by Oracle®, other program, or a combination thereof that automates the packaging, deployment, and execution of applications inside containers.

Each of the containers 125A-C may refer to a resource-constrained process space of node 120 that can execute functionality of a program. Containers 125A-C may be referred to as a user-space instances, a virtualization engines (VE), or jails and may appear to a user as a standalone instance of the user space of operating system 123. Each of the containers 125A-C may share the same kernel but may be constrained to use only a defined set of computing resources (e.g., CPU, memory, I/O). Aspects of the disclosure can create one or more containers to host a framework or provide other functionality of a service (e.g., web application functionality, database functionality) and may therefore be referred to as “service containers” or “application containers.”

Pods 129A and 129B may be data structures that are used to organize one or more containers 125A-C and enhance sharing between containers, which may reduce the level of isolation between containers within the same pod. Each pod may include one or more containers that share some computing resources with another container associated with the pod. Each pod may be associated with a unique identifier, which may be a networking address (e.g., IP address), that allows applications to use ports without a risk of conflict. A pod may be associated with a pool of resources and may define a volume, such as a local disk directory or a network disk and may expose the volume to one or more (e.g., all) of the containers within the pod. In one example, all of the containers associated with a particular pod may be co-located on the same node 120B. In another example, the containers associated with a particular pod may be located on different nodes that are on the same or different physical machines.

Repository 130 may be any data store that is capable of storing one or more images, storage metadata, storage lease information, etc. The images may include container images, virtual machine images, disk images, other images, or a combination thereof. Repository 130 may include block-based storage devices, file-based storage devices, other storage device, or a combination thereof. Block-based storage devices may provide access to consolidated block-based (e.g., block-level) data storage and may include one or more devices (e.g., Storage Area Network (SAN) devices). Block-based storage devices may be accessible over a network and may appear to an operating system of a computing device as locally attached storage. File-based storage devices may provide access to consolidated file-based (e.g., file-level) data storage using one or more data storage devices (e.g., Network Attached Storage (NAS) devices) that may be accessible over a network. In one example, a secondary storage with repository 130 may employ block-based storage and the images, storage metadata, and storage lease may be provided by respective logical volumes. In another example, the secondary storage with repository 130 may employ file-based storage and the images, storage metadata, and storage lease may be provided by one or more respective files. In the example shown in FIG. 1, repository 130 includes container images 132A-C, rules 134, and readiness factors 136.

Container images 132A-C may include one or more computer programs along with a filesystem that contains the computer code, runtime, system tools, system libraries, other data, or a combination thereof to support the execution of a service within a container on node 120B. The container images 132A-C may not include an operating system but may be loaded and run by an operating system virtualizer that is part of operating system 123 of node 120B. Each of the container images 132A-C may include one or more data structures for storing and organizing information that may be used by node 120B to provide a computing service. The information within container images 132A-C may indicate the state of the image and may include computer code (e.g., machine code), configuration information (e.g., settings), or content information (e.g., file data, record data). Each of the container images 132A-C may be capable of being loaded onto node 120 and may be executed to provide one or more services. A plurality of rules 132 may be used to analyze the set of processes to determine a candidate set of processes for building the container images 132A-C. Conversion 111 may be performed in view of the plurality of rules 132. Readiness factors 136 may be used to determine whether service requests may be routed to containers supported by container images 132A-C.

FIGS. 2 and 3 are block diagrams illustrating example components and modules of agent 116 and manager 110 respectively, in accordance with one or more aspects of the present disclosure. Agent 116 may be the same or similar to agent 116 of FIG. 1 and manager 110 may be the same or similar to manager 110 of FIG. 1. The components, modules, or features discussed in regards to agent 116 and manager 110 may be consolidated to the agent 116, consolidated to the manager 110, or be spread in any manner across both entities. For example, features discussed below in regards to manager 110 may be executed by agent 116 or vice versa.

Referring to FIG. 2, Agent 116 may include one or more computer programs or program components that are capable of accessing the virtual machine. The one or more computer programs or program components may be installed into the guest operating system (e.g., as an application or driver), the virtual machine (e.g., as an emulation or virtualization feature), a hypervisor, a host operating system, or a combination thereof. The installation of the agent 116 may be initiated by the device executing the manager 110 or by a user (e.g., IT administrator). Agent 116 may access content of the virtual machine while the virtual machine is active (e.g., an executing virtual machine image), while the virtual machine is inactive (e.g., dormant virtual machine image), or a combination thereof. In one example, agent 116 may be executed by the virtual machine that is being inspected or by another computing device with access to the virtual machine being inspected. In the example, shown in FIG. 2, agent 116 may include a virtual machine inspection component 210, a data transmission component 220, and a data store 230.

Virtual machine inspection component 210 may enable agent 116 to inspect the virtual machine to identify data indicating a configuration of the virtual machine and a set of processes executed by the virtual machine. The configuration of a virtual machine may relate to data of the guest operating system, running processes, filesystem, other data, or a combination thereof. The data may include operational data that relates to an operational state (e.g., transient state, changing state) of the virtual machine and one or more processes or may relate to non-operational data such as settings of the virtual machine or guest operating system. The data may include ephemeral data that may correspond to processes while they are being executed and may cease to exist when the processes are shut down.

The modules of virtual machine inspection component 210 may gather the configuration data by executing one or more operations. The operations may be any command, instruction, procedure, function, executable, utility, other action, or a combination thereof. The operation may be specific to the guest operating system or may be generic to one or more guest operating systems. The operation may return configuration data as textual data, binary data, other data or a combination hereof. The data may be in the form of one or more strings, streams, lists, tables, files, records, other data structures, or a combination thereof. In one example, virtual machine inspection component 210 may execute operations that are the same or similar to a table of processes (TOP) operation that lists running processes, a network mapper (NMAP) operation that enumerates open ports, memory (MEM) operation that provides memory use details, other operation, or a combination thereof.

Virtual machine inspection component 210 may also or alternatively execute operations to gather data using a configuration pseudo-filesystem. The configuration pseudo-filesystem may represent process information, kernel information, system information, other information, or a combination thereof using a hieratically organized directory structure. This may enable virtual machine inspection component 210 to use traditional filesystem operations to navigate the configuration pseudo-filesystem to gather data of virtual machine. For example, the configuration pseudo-filesystem may be mapped to a mount point and one or more of the directories may correspond to particular processes (e.g., particular PIDs). In one example, the configuration pseudo-filesystem may be the same as the Unix or Linux based proc filesystem (ProcFS), system filesystem (SysFS), other filesystem, or a combination thereof. In one example, virtual machine inspection component 210 may gather data from the virtual machine using an operating system inspection module 212, a process inspection module 214, and a storage inspection module 216.

Operating system inspection module 212 may analyze the operating system to identify features of the operating system. The features of the operating system may include operating system type data, release data, version data, build data, patch data, other operating system indication data, or a combination thereof. It may also indicate one or more programs that have been installed on the virtual machine. The programs may have been installed by an end user (e.g., IT administrator) or come pre-installed with the operating system from the operating system developer (e.g., Microsoft®) or computer manufacturer (e.g., IBM®, Dell®, HP®). The programs may be standalone programs or may be included within one or more packages.

Process inspection module 214 may enable agent 116 to inspect the virtual machine to identify configuration data that indicates the processes running on the virtual machine and the operational status of the processes (e.g., operational data). The configuration data gathered by process inspection module 214 may include any information associated with a process. The information may include one or more process identifiers (e.g., PID), process computer code (e.g., source code, interpretable code, intermediate code, object code, binary code, executable code), code location, process entry points (command line parameters, initialization parameters), process working directories, process networking identifier (e.g., ports, sockets), process tokens (e.g., security token, key, identifier), process credentials (e.g., username and passcode), process owner (e.g., user or system account), process priority, process running duration threshold, other information, or a combination thereof.

Storage inspection module 216 may inspect the persistent storage associated with the virtual machine. This may involve one or more operations to determine data about the filesystem or content stored by the filesystem. The data about the filesystem may include filesystem type data, filesystem version data, other data, or a combination thereof. The data stored by the filesystem may include the data associated with one or more filesystem objects. Storage inspection module 216 may gather data by executing one or more operations to search content of one or more filesystems of the virtual machine. The operations may identify content of the filesystem, which may include files, directories, filesystem metadata, other data, or a combination thereof. In one example, the operations may include filesystem navigation operations (e.g., change directory (CD) command) as well as reading, writing, execution, other operations, or a combination thereof.

Data transmission component 220 may access data identified by virtual machine inspection component 210 and may process the data prior to transmitting it to manager 110. In one example, data transmission component 220 may include an extraction module 222 and an encoding module 224.

Extraction module 222 may enable agent 116 to analyze the configuration data identified by the above inspection modules and extract portions of the data for use by manager 110. Extraction module 222 may execute one or more operations that extract data, filter-out data, segment data, remove data, modify data, add data, create data, other operation, or a combination thereof.

Encoding module 224 may encode the data of the virtual machine into a message that can be transmitted to manager 110. The encoding may include compression, encryption, other operation, or a combination thereof. The encoding may effect the configuration data, extracted data, other data, or a combination thereof and may result in encoded data. The encoded data may then be transferred to the manager over one or more connections and the connections may include connections between nodes on the same physical device or between nodes on different devices. The connections may also or alternatively include network connections and the encoded data may be sent over a network to a separate computing device executing the manager.

Referring to FIG. 3, components and modules of manager 110 may be illustrated as a block diagram, in accordance with one or more aspects of the present disclosure. Manager 110 may be the same or similar to manager 110 of FIG. 1 and may include a provisioning component 112, an orchestration component 114, and a data store 330. Data store 330 may include various data, including rules 134, computer code 332, parent image 336, container image 132, readiness factors 136, etc.

Provisioning component 112 may analyze and processes the data of the virtual machine that was identified by the agent. In one example, provisioning component 112 may include a data receiving module 312, a rules engine module 314, a candidate determination module 316, and a container building module 318.

Data receiving module 312 may enable manager 110 to receive data of the virtual machine from the agent 116. The data of the virtual machine may indicate the configuration of the virtual machine and a set of processes executed by the virtual machine. The data of the virtual machine may be the data collected by agent 116 as described with reference to FIG. 2. The set of processes may comprise one or more of a web server process, a database process, a filesystem process, a user authentication process, or an electronic mail process.

Rules engine module 314 may analyze the data received from the agent in view of one or more rules. The rules engine may analyze the set of processes in view of a plurality of rules. The rules may be defined by an IT administrator, service designer, end user, other source, or a combination thereof. The rules engine may also accept values as variables dynamically passed from a computer program, or a user interface. The rules may be stored in a data structure (e.g., a CSV format). For example, the rules may be stored in data store 330 as rules 134.

Rules engine module 314 may comprise various types of rules. For example, rules engine module 314 may define kernel level rules, service level rules, management rules, etc. For example, the kernel level rules may enable manager 110 to identify operating system (“OS”) specific processes (e.g., system processes that are exclusive to the operating system) that are already included within the operating system managing the containers and do not need to be executed within a container. The kernel level rules may indicate to exclude the identified OS specific processes from a candidate set of processes to be used to build container images. In some examples, kernel level rules may identify a mapping of virtual machine operating systems (i.e. kernels) to available base images for building container images.

In some examples, service level rules may identify various processes that may be used to provide one or more services. Service level rules may identify the name or location of a given process, and one or more processes and/or services having interdependency associated with the given process. An example of interdependency may include a runtime execution dependency between processes. The given process may depend on the one or more processes and/or services in order to fully execute the given process. In one example, based on the dependency of processes within the virtual machine, equivalent software packages may be installed within a container to execute the given process. The rules may indicate to include the processes in the candidate set of processes for building container images if the given process is selected to be included in the candidate set of processes. In some examples, the service rules may identify the kernel used on the virtual machine environment that the given process runs on, and a base image that corresponds to the kernel that can be used in building the container images. The rules may also designate a particular base image that is desired to be used so that the services may run on that particular base image within the container. The service rules may also provide an order of priority associated with each of the candidate processes and/or services. In an example, the processes for the candidate services may be analyzed for containerization in the order of priority. In another example, container images with the processes may be built in the order identified for the candidate processes. The ordering may also be indicated based on criteria identified on the rules engine, such as, alphabetical process name, running state of process, customized value passed by user, etc.

Rules engine module 314 may include management rules. For example, management rules may identify one or more processes which are to be excluded (e.g., an exclusion list) from a candidate set of processes for building container images. For example, rules engine module 314 may enable manager 110 to identify transient services that execute on the virtual machine but are identified in the rules as not being candidates for conversion. The transient services may be those that are generally short lived, and/or not useful services. The rules may also identify processes that tend to generate multiple threads for the same service, so that duplicate processes may be removed from candidate set of processes for containerization. Management rules may also identify one or more processes that are to be included (e.g., an inclusion list) in the candidate set of processes for building container images. In some examples, the processes to exclude or include may be identified by dynamically passing values from a computer program or user interface. In some examples, the exclusion or inclusion of processes may be designated within the rules engine based on business requirements. While one organization may designate a process to be on the exclusion list, another organization may designate the same process to be on the inclusion list, or remain neutral about the process by not particularly identifying the process in either of the exclusion or inclusion list. Thus, the containerization effort may be customized based on the needs of a particular client.

In some examples, management rules may identify level of automation for the conversion from virtual machines to containers. In an example, the rules may designate an integer value (such as, “1”) to indicate a “constant feedback method” whereby at each stage of conversion, a user (such as an IT administrator) may be presented with the output of that stage and be asked whether the process of conversion may continue. The user may be given the option to provide an appropriate instruction, such as to continue, to discontinue, etc. The rules may designate another integer value (such as “2”) for a “major decision feedback method” whereby the conversion process may be temporarily halted for feedback from the user for a major decision identified by the rules. Another option may be yet another integer value (such as “3) to indicate a “complete autonomous method” whereby no feedback, or minimal feedback, may be required from the user. Candidate determination module 316 may determine, based on the analysis of the set of processes using the rules, a set of candidate processes for building a plurality of container images. The analysis from the rules engine module 314 may identify processes to exclude from containerization (e.g., excluding operating system level processes, transient processes, duplicate processes, etc.) or to include in the containerization effort. Using the analysis from the rules engine module, candidate determination module 316 may filter the set of processes received from agent 116 to determine a subset of processes which are to be considered as candidate processes for conversion to containers. In some examples, the determination of candidate processes may be based on dependencies identified using the rules engine module 314. The dependencies may include code building dependences (e.g., compiler dependences, linking dependencies), runtime executable dependences (e.g., package, library, or function dependencies), data dependencies (e.g., settings), account dependency (e.g., particular account, credentials, or token), content dependence (e.g., file or record), other dependency relationship, or a combination thereof. In an example, a particular process may be identified by the candidate determination module 316 to be a candidate process for containerization. If the particular process is identified in the rules engine to depend on a second process, then the second process may also be determined as a candidate process for containerization.

Container building module 318 may build a plurality of container images in view of the set of candidate processes determined by candidate determination module 316. Container building module 318 may identify computer code 332 associated with one of or more of the candidate processes. Computer code 332 may include any code associated with one or more of the processes and may include source code, executable code, other code, or a combination thereof. The source code may include human readable computer code that is in a textual form. The source code may be subsequently compiled, linked, interpreted, other action, or a combination thereof prior to being executed by the virtual machine or within a container. The executable code may include machine-readable code that can be directly executed by a machine or indirectly executed by a machine (e.g., intermediate code).

Container building module 318 may identify the computer code in view of the configuration data received from the agent. In one example, the configuration data may include some or all of the computer code. In another example, the configuration data may indicate a location where some or all of the computer code is accessible (e.g., storage location). The location may be local to the virtual machine (e.g., on same physical device) or may be remote from the virtual machine on a storage device that is accessible over a network. Container building module 318 may access the data received from agent 116 and use the data to build one or more container images (such as, container image 132) that collectively include the services (e.g., processes) provided by the virtual machine. Container building module 318 may analyze the computer code and the configuration data to detect links and/or dependencies between a candidate process and other content of the virtual machine.

Container image 132 may include the computer code of one or more processes of a particular service along with filesystem data that contains the runtime, system tools, system libraries, other data, or a combination thereof to support the execution of the service within a container. Container image 132 may be capable of being initiated by a computing device (e.g., node) and may be loaded to perform one or more processes of a service. Container image 132 may be absent (free, missing, without) operating system or kernel libraries but may be loaded and run by an operating system virtualizer that is part of an existing operating system. Container image 132 may include one or more data structures for storing and organizing information in a format that can be interpreted by the operating system virtualizer and executed by a processing device to provide the service.

The format of container image 132 may be based on any open standard, proprietary format, other format, or a combination thereof. The information within container image 132 may indicate the state of the image and may include executable information (e.g., machine code), configuration information (e.g., settings), or content information (e.g., file data, record data). In one example, container image 132 may include textual data that indicates the name, tag, and architecture of the image and may also include one or more data structures representing one or more layers of the image. The data structures may include schema version data, index data (e.g., digest data or hash data) of filesystem objects, and history data indicating one or more parent or child layers. In one example, the format may be based on a docker image manifest (e.g., docker image manifest V2, Schema 1), an open container initiative (OCI) specification, other container format, or a combination thereof.

Container building module 318 may access the data of the virtual machine and identify a corresponding image from a repository that will function as parent image 336. Parent image 336 may be a template image that is pre-built and may be identical to a base image or may be a modified version of a base image. The base image may be publicly available and may correspond directly to a particular operating system (e.g., Fedora®, Windows®, Mac®). Container building module 318 may attempt to select a parent image that corresponds directly to the operating system of the virtual machine or may select a base image that is a variation of the operating system. The variation may be an earlier version, the same version, or a later version of the operating system of the virtual machine and may include one or more enhancements (e.g., security or performance modifications). The variation may be based on a version of the operating system that includes more or less features and may execute on the same or different hardware architecture.

Container building module 318 may access parent image 336 and may update the parent image 336 to create a container image 132 that includes the one or more processes of the virtual machine from the set of candidate processes. Creating container image 132 may involve one or more operations that copy the computer code of one or more processes of a service into container image 132. In one example, container building module 318 may copy the computer code from a version management control application (e.g., GIT) by executing RUN GIT clone path/to/src.git. In another example, the computer code may be copied using an operating system copy operation. In yet another example, the computer code may be made accessible to the container without executing a copy operation by mounting the storage location of the computer code. This may be the same location used by the virtual machine to access the computer code.

Container building module 318 may generate or use a build file to update or create container image 132. Each container image may be associated with a build file and the build file may be referred to as an instruction file, an assembly file, a docker file, other file, or a combination thereof. The build file may include textual data, binary data, other data, or a combination thereof. In one example, the build file may be a text document that contains instructions (e.g., command line commands) that are interpreted by a container image creation service (e.g., docker service) to assemble a container image. Each instruction may correspond to a layer that will be associated with or included within the container image. The layers enable multiple images that inherit from the same parent image to share many of the same filesystem objects (e.g., files, directories, packages, libraries). This may reduce the total amount of computing resources (e.g., storage resources) consumed by the operating system level virtualization when running multiple containers that share layers. The reduction of computing resources may be accomplished by avoiding the need for multiple copies of the same layer to be loaded.

Container building module 318 may store the updated container image and one or more build files on a storage device. The storage device may be a repository (e.g., a repository of computer images) that is accessible to a node that provides operating system level virtualization. Container building module 318 may also update an image registry with information associated with the container image such as one or more build files, locations, other data, or a combination thereof. The data of the image registry may be used to subsequently initiate the execution (e.g., instantiation) of a container using the container image on a computing device comprising operating system level virtualization. Even though container image 132 has been used in the above description to refer to a single container image, the same operations and functions as applied with reference to container image 132 may be applied to create and process a plurality of container images.

Orchestration component 114 may ensure stability of client requests for various services by routing service requests to the virtual machine and/or the newly built containers. Orchestration component 114 may be used for preparing for switching off services on virtual machines and migrating traffic to the new containerized services in an intelligent manner. The system may receive internal and/or external system calls from customers with service requests expect results back from the system. The system calls may be accompanied with some form of an input and the expected result may be some form of an output. Orchestration component 114 may allow for the services to be satisfactorily provided to the customers when services are being migrated from virtual machines to containers. Orchestration component 114 may ensure that the requests for services from customers are seamless to customers and the response mechanism is invisible to end customers. The orchestration component may allow for a customizable way to maintain both the virtual machine environments and the containerized environments on a side by side manner, reducing and mitigating risks. It may allow for a live migration of services in a production environment without service interruptions. The orchestration component may facilitate migration of services in increments (e.g., piece by piece), ensuring uniformity in terms of service offerings.

In one example, orchestration component 114 may include a readiness detection module 322, a routing agent 324, a termination module 326, and a container execution module 328.

Readiness detection module 322 may analyze each of the container images stored on a storage device to determine whether service requests can be satisfied using containers supported by the container images. Readiness detection module 322 may analyze the container images in view of a variety of readiness factors. Readiness factors may be derived by a computer algorithm, or defines by an end customer, user, an IT administrator, or the combination thereof. As such, readiness factors may be customizable.

Readiness factors 136 may be stored on data store 330. In some examples, each of the readiness factors may be associated with a numeric value, an alphanumeric value, a real number, a binary value, a Boolean value (e.g., True or False), an integer value, a percentage value, a text character (e.g., “ready,” “not ready,” “yes,” “no,” etc.), or a combination thereof. These values may indicate a level of readiness for each factor. Each of the readiness factors 136 may be associated with a weight. Each of the readiness factors 136 may carry the same or different weights. The readiness factors may be prioritized based on various criteria, such as, technical necessity, business requirements, etc. In some examples, some readiness factors may be required and must be satisfied before a service request is routed to the containers. Some readiness factors may be optional. Some readiness factors may be used to provide additional confidence regarding the performance of the newly built container images. In some examples, a combination of readiness factors may be used to decide the routing of requests to containers and termination of services on virtual machines.

Readiness detection module 322 may calculate an aggregate score based on the readiness factors to indicate the readiness of each of the container images. Routing agent 324 may utilize the aggregate score to determine whether to route service requests to containers supported by container images. The aggregate score may be based on one or more factors, and may take into consideration the priority, weights, and/or whether the factors are required or optional. In one example, an aggregate score may be calculated based on a weighted value of each of the one or more readiness factors considered for the aggregate score. A weighted value may be calculated by multiplying a value (e.g., a numeric value, a numeric equivalent of alphanumeric or other types of values, etc.) assigned to each readiness factor with a weight assigned to the corresponding readiness factor. The weighted value for each of the readiness factors may be added to find a total weighted value for the plurality of readiness factors. In some examples, the total weighted value may be divided by the number of readiness factors to derive an average weighted value for the plurality of readiness factors. The total weighted value or the average weighted value may be used as the aggregate score. However, any other algorithm, formula, or logic may be used to derive an aggregate score for the readiness factors.

There may be different threshold levels associated with the aggregate score based on the readiness factors 136. In some examples, the threshold levels may be designated for initiating performance of different operation or tasks. For example, if the aggregate score for a particular container image is above a first threshold level, routing agent 324 may begin to route service requests to the container supported by the particular container image. If a second threshold level is met, the service requests may be routed more frequently to the containers. For example, the service requests may be routed to the containers at a higher rate per minute than the rate used prior to reaching the second threshold level. If a third threshold level is met, service requests may be exclusively routed to the containers, instead of virtual machines. If a fourth threshold level is met, services (e.g., processes of the service) may be terminated from the virtual machine. There may be additional threshold levels for additional activities, operations, and/or tasks. The threshold levels may be customizable and based on requirements of a customer.

One of the readiness factors 136 may include process equivalency between virtual machines and containers images. For example, referring to FIG. 1, the computer code of one or more processes of a service 128A within virtual machine 124 maybe copied to create a container image 132 for supporting service 128A within container 125A. As the container image 132 is built and processes are deployed within the container, the processes of service 128A on virtual machine 124 may be compared to the new processes on the container image 132. For example, data indicating processes of the virtual machine 124 is received from the agent 116. For example, the data may include a proc file associated with a process, as described with reference to FIG. 2. A comparison may be performed between the proc file as received from agent 116 for virtual machine 124 and a proc file obtained for processes within the container image 132. The comparison results may indicate whether the proc files, and associated configuration, are equivalent between the virtual machine 124 and container 125A. In an example, if the processes in the virtual machine and container images are indicated as equivalent (e.g., equal, comparable, same, etc.), then the container image 132 may be considered ready to run processes of service 128A, satisfying the readiness factor of process equivalency.

Readiness factors 136 may include metadata level matching, that is, an indication that metadata related to service 128A running on virtual machine 124 matches metadata of service 128A running on container 125A. Readiness factors 136 may include file system availability, that is, an indication that one or more files that are accessible by a process within virtual machine 124 are available and accessible to the process within container image 132 supporting container 125A.

Readiness factors 136 may include process interdependency satisfaction. As described previously, a process running on a virtual machine may be dependent on one or more other processes and services, output of those processes or services, and/or files associated with those processes and services. Some of these interdependencies may be identified by the rules 134, some may be identified by the data received from agent 116, etc. One of the readiness factors 136 may indicate satisfaction of dependencies between interdependent processes within the container. For example, an indication may be provided as to whether or not one or more processes or services on which the processes of service 128A of the virtual machine 124 depends on have also been migrated over to the containerized system, or whether each of the dependencies have been otherwise satisfied.

Readiness factors 136 may include factors related to performance of services on the newly built containers. Once routing agent 324 begins to route some service requests to the containerized environment, performance statistics may be obtained for services running on the containers. Thus, readiness detection module 322 and routing agent 324 may perform tasks side by side and use results from one another.

Routing agent 324 may determine whether to send a service request to a virtual machine or a container, or both. Routing agent 324 may use a routing proxy that maintains a list of service end point destinations. For example, the service end point destinations may include end point destinations for service 128A, 128B, 128C of virtual machine 124, and service 128A of container 125A, service 128B of container 125B, service 125C of container 125C, etc., as depicted in FIG. 1.

As described above, based on containers image satisfying one or more readiness factors (e.g., meeting certain threshold score, etc.), routing agent 324 may begin to route some service requests to services within the containers. In an example, at a given time, service 128A and 128C may be indicated as available within their respective containers, 125A and 125C based on one or more or readiness factors 136, while service 128B may not be indicated as available yet within container 125B. Routing agent 324 may receive service requests for services 128A, 128B, and 128C from a client. Routing agent 324 may route the request for service 128B to virtual machine 124. Routing agent 324 may route the service requests for service 128A and 128C to either the virtual machine 124, or the containers 125A and 125B, respectively, or to both. A determination may be made by the routing agent based on a load balancing algorithm, further readiness factors, or a combination thereof.

Routing agent 324 may use various load balancing algorithms used in the industry. For example, the load balancing algorithms may include, but not be limited to, one or more of round robin, weighted round robin, mirroring, least traffic, least latency, least connection, source IP hash, etc. For example, using a round robin technique, service requests may be routed in a rotating sequence such as a first request is sent to the virtual machine, a second request is sent to the containers, a third request is sent to the virtual machine again, and repeating in such a sequence. In an example, using round robin, service request for service 128A may be routed to virtual machine 124, and service request 124C may be routed to container 125C. In another example, using a mirroring technique, each request may be sent to both the virtual machine 124 and the containers 125A and 125C, respectively. Using mirroring techniques, routing agent 324 may be able to provide for analysis of the results and verify that same results are obtained from both the virtual machines and the containers. The routing agent may be customized based on the customer requirements and can be driven by rules defined in the system (such as, rules 134) and data analysis based on data from agent 116.

As routing agent 324 begins to route service requests to containers, performance data may become available for further analyzing readiness of container images based on readiness factors related to performance of services on containers. With regards to performance of services, readiness detection module 322 may use individual performance indicators as factors, or utilize a performance readiness algorithm that can be based on a plurality of performance indicators associated with a service executed within the container. In an example, the performance readiness algorithm may accept as input performance indicators, such as, number of requests, number of successful requests, number of failed requests, etc. and provide a performance score. Various other performance statistics may be used as input to derive the performance score. In an example, the algorithm may perform a binary comparison of the performance indicators for output expected and/or received on the virtual machine side and the output received on the container side. In an example, the algorithm may perform a hashing function on the output to derive a performance score. The performance score may be used as one of the readiness factors.

Readiness detection module 322 may also consider latency in terms of service request responses. For example, a container may not be considered as being ready until the network used by the containers has been optimized such that responses are received within a certain time window, such as those time windows specified by a Service Level Agreement (SLA) with a customer. If SLA requirements are not met in terms of latency, it may be an indicator that some mistake or problem exists with the conversion effort. For example, the network may have been incorrectly configured, the container may not have enough resource processing power, one or more prerequisites for the service may have been missed during the conversion, etc. A latency measurement may provide indication that a manual intervention may be necessary or desirable.

In terms of performance or latency related factors, each customer may have a customized threshold as to when manual intervention may be necessary, when a containerized environment may be considered ready, whether services may be terminated from virtual machines, etc. For example, for a client that can accept very low error tolerance (such as, financial institutes, national security organizations, etc.), the threshold may be set to a very high value (e.g., 99% or 100% requests being successful or within SLA). In other examples, a client that may have alternative safety measurements, built in redundancies in case of failures, the threshold may be set to a lower value (e.g., 90% requests being successful or within SLA time) for the containers as being considered ready. Additionally, the threshold may be higher in a production environment, whereas in a development or staging environment, the threshold may be lowered as errors may not have significant consequences in development or staging environments. The readiness detection module 322 may assist with determining the overall status of a migration effort from virtual machines to containers, the expected time to complete migration, the amount of additional work necessary, the amount of manual inventions necessary, etc.

Termination module 326 may terminate a process executed by the virtual machine from running within the virtual machine. Termination module 326 may determine a process is ready to be turned off from a virtual machine based on analysis from the readiness determination module 322. For example, readiness determination module 322 may determine that a process of a service 128A executed on the virtual machine 124 (referring to FIG. 1) can be executed within container 125A supported by newly built container image 132. This may satisfy a readiness factor 136. Once this readiness factor is satisfied, termination module 326 may terminate the process from virtual machine 124. In another example, the client may require additional readiness factors to be satisfied prior to terminating a process from virtual machines. In some example, a client may set a threshold level for the aggregate score for readiness factors and/or another threshold level for the performance score for a container image. If the threshold level is met, a process running within a container supported by the container image may be terminated from the virtual machine. One or more processes from the virtual machine may be terminated by the termination module 326. When all processes supporting a service is terminated, the service may be considered to be switched off from the virtual machine. At this point the routing agent may route request for that specific service exclusively to the container. All services of the virtual machine may be terminated at a certain stage by the termination module 326. When all services of all virtual machines in a particular environment is turned off, the migration of services from virtual machines to containers may be completed.

Container execution module 328 may instantiate (e.g., initiate) a container using a container image and execute a process within the container. For example, when routing agent 324 routes a service request to a service within a container, container execution module 328 may initiate the container using container image 132. Container execution module 328 may execute a process within the container. For example, when a container image is indicated as ready, and a process is indicated as executable within a container supported by the container image, the container execution module 328 may instantiate the container and may execute the process within the container when a service request is routed to the container. In an example, when a service request for service 128B is routed to container 125B of node 120B, container execution module 328 may instantiate the container 125B and may execute one or more processes of service 128B within the container 125B.

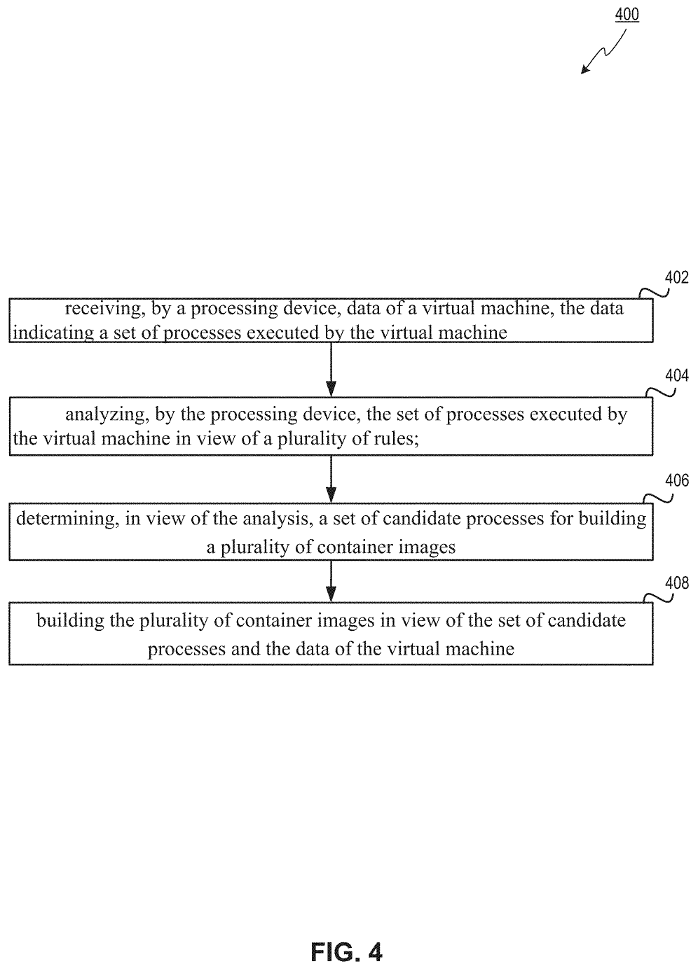

FIGS. 4, 5 and 6 depict flow diagrams for illustrative examples of methods 400, 500, and 600 for converting services from being within a virtual machine to one or more containers. Method 400 illustrates an example process flow for converting services executed by a virtual machine to one or more container images. Method 500 is an example process flow for determining readiness of services within a container to route service requests to the container. Method 600 is an example process flow for converting services executed by a virtual machine to one or more container images and routing services to a container supported by the container images. Methods 400, 500, and 600 may be performed by processing devices that may comprise hardware (e.g., circuitry, dedicated logic, programmable logic, microcode, etc.), executable code (such as is run on a general purpose computer system or a dedicated machine), or a combination of both. Methods 400, 500, and 600 and each of their individual functions, routines, subroutines, or operations may be performed by one or more processors of the computer device executing the method. In certain implementations, methods 400, 500, and 600 may each be performed by a single processing thread. Alternatively, methods 400, 500, and 600 may be performed by two or more processing threads, each thread executing one or more individual functions, routines, subroutines, or operations of the method. In an illustrative example, the processing threads implementing methods 400, 500, and 600 may be synchronized (e.g., using semaphores, critical sections, and/or other thread synchronization mechanisms). Alternatively, the processes implementing methods 400, 500, and 600 may be executed asynchronously with respect to each other.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, methods 400, 500, and 600 may be performed by provisioning component 112 and orchestration component 114 as shown in FIGS. 1 and 3.

Referring to FIG. 4, method 400 may be performed by processing devices of a server device or a client device and may begin at block 402. At block 402, the processing device may receive data of a virtual machine. The data may indicate a set of processes executed by the virtual machine. The set of processes may include one or more of a web server process, a database process, a filesystem process, a user authentication process, an electronic mail process, other process, or a combination thereof. The data may be associated with or related to data of the guest operating system, running processes, filesystem, other data, or a combination thereof. The data may include operational data that relates to an operational state of the virtual machine and one or more processes or may relate to non-operational data such as virtual machine or guest operating system settings. The data may include persistent data (e.g., non-ephemeral data) or transient data (e.g., ephemeral data), which may correspond to programs while they are being executed and may cease to exist when the programs are shut down.

At block 404, the processing device may analyze the set of processes executed by the virtual machine in view of a plurality of rules. The plurality of rules may include one or more of: a first rule identifying one or more operating system specific processes and the first rule indicates to exclude the one or more operating system specific processes from the set of candidate processes, a second rule identifying a first process and one or more second processes having interdependency associated with the first process, a third rule identifying one or more third processes to exclude from the set of candidate processes, a fourth rule identifying one or more fourth processes to include in the set of candidate processes, a level of automation for conversion of virtual machine services to containerized services, or other rules related to the set of processes.

At block 406, the processing device may determine a set of candidate processes for building a plurality of container images based on the analysis of the set of processes in view of the plurality of rules. The analysis in view of the plurality of rules may be used to identify processes to exclude from containerization (e.g., excluding operating system level processes, transient processes, duplicate processes, etc.) or to include in the containerization effort. Using the analysis, the processing device may filter the set of processes executed by the virtual machine to determine a subset of processes which are to be considered as candidate processes for conversion to containers. In some examples, the determination of candidate processes may be based on dependencies identified using the plurality of rules.

At block 408, the processing device may build the plurality of container images in view of the set of candidate processes and the data of the virtual machine. Each of the plurality of container images may include computer code of one or more of the set of candidate processes. Building the plurality of container images may include identifying an order associated with each process of the set of candidate processes indicated in the plurality of rules and building the plurality of container images in view of analyzing the set of candidate processes in the identified order. Building the container image may involve building a plurality of container images that collectively comprise the set of processes executed by the virtual machine. The container image may enable the computer code of the one or more of the set of candidate processes to execute within a container using operating system level virtualization. Building the container image may involve selecting a parent container image in view of the configuration of the virtual machine. The parent container image may include a base image corresponding to a guest operating system of the virtual machine. In one example, the processing device may copy the parent container image from a public repository comprising a plurality of container images and may modify the parent container image to comprise the computer code of the first process. After building the container image, the processing device may store the container image on a storage device accessible over a network. The processing device may also or alternatively register the container image with a repository comprising a plurality of container images. The processing device may or may not initiate execution of the container image on a computing device comprising operating system level virtualization.

Alternate examples of method 400 may also involve the processing device installing an agent on a first computing device (e.g., node) that executes the virtual machine. The agent may run as a portion of one or more of the guest operating system, the virtual machine, a hypervisor, or a host operating system of the first computing device. The processing device may initiate, over the computer network, the agent on the virtual machine to inspect the configuration of the virtual machine. The processing device may be a part of a second computing device and may receive data from the agent executing on the first computing device, wherein the first computing device and second computing device are separated by a computer network. In one example, the virtual machine may be managed by a hypervisor executing on a physical machine, and the data indicating the configuration of the virtual machine and the set of processes may be obtained during execution of the virtual machine. In another example, the data indicating the configuration of the virtual machine and the set of processes may be obtained from a virtual disk image of the virtual machine while the virtual machine is dormant.

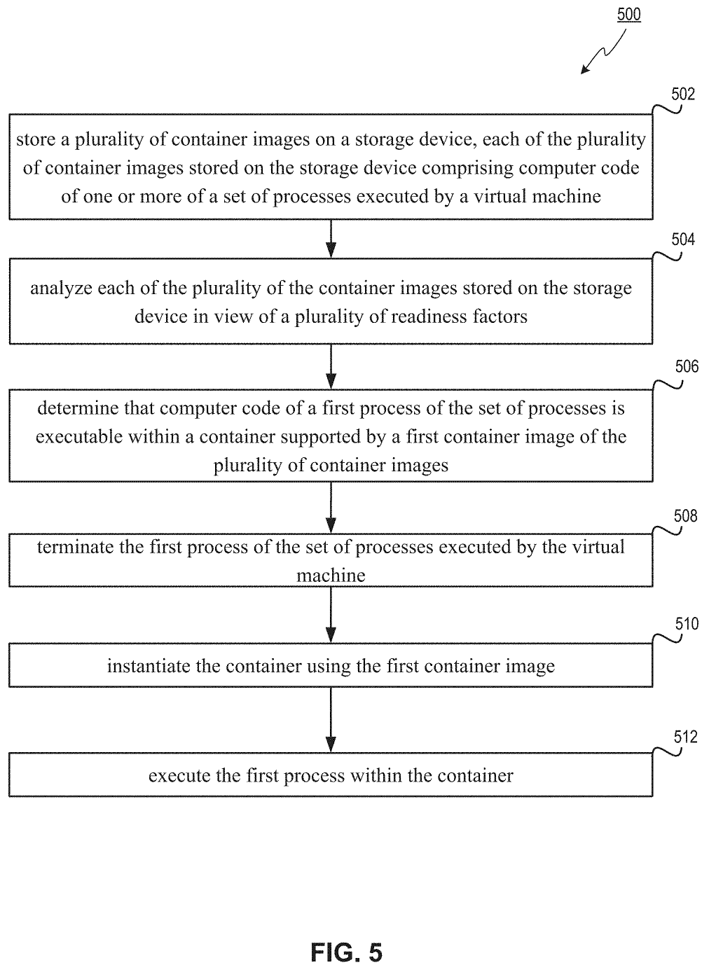

Referring to FIG. 5, method 500 may be performed by processing devices of a server device or a client device and may begin at block 502. At block 502, the processing device may store a plurality of container images on a storage device. The processing device may store the container image on a storage device accessible over a network. Each of the plurality of container images stored on the storage device may include computer code of one or more of a set of processes executed by a virtual machine. The set of processes may include one or more of a web server process, a database process, a filesystem process, a user authentication process, an electronic mail process, other process, or a combination thereof. The plurality of container images may collectively comprise the set of processes executed by the virtual machine. The container image may enable the computer code of the one or more of the set of candidate processes to execute within a container using operating system level virtualization.

At block 504, the processing device may analyze each of the plurality of the container images stored on the storage device in view of a plurality of readiness factors. The plurality of readiness factors may comprise one or more of: equivalency between a particular process within the virtual machine and the particular process within the container, metadata level matching between processes within the virtual machine and the container, file system availability within the container, satisfaction of dependencies between interdependent processes within the container; performance indicator of one or more services executed within the container, or other readiness factors associated with the container images. The processing device may calculate an aggregate score associated with each of the plurality of the container images in view of one or more of the plurality of readiness factors. The processing device may analyze each of the plurality of container images in view of the aggregate score.

At block 506, the processing device may determine that computer code of a first process of the set of processes is executable within a container supported by a first container image of the plurality of container images. The determination may be based on the analysis performed in view of the readiness factors. In addition, the processing device may determine that the first container image satisfies at least one of the plurality of readiness factors; and in response, route a request for a service to the container supported by the first container image.

At block 508, the processing device may terminate the first process of the set of processes executed by the virtual machine. The processing device may terminate the first process based on determining that the aggregate score associated with the first container image satisfies a first threshold level specified in the system. In addition or alternatively, to terminate the first process executed by the virtual machine, the processing device may obtain a performance score by executing a performance readiness algorithm. The performance readiness algorithm may be executed in view of a plurality of performance indicators associated with a service executed within the container. The processing device may terminate the first process of the set of processes executed by the virtual machine in view of the performance score satisfying a second threshold level specified in the system.

At block 510, the processing device may instantiate the container using the first container image. The processing device may instantiate the container using the first container image by initiating the execution of the first container image on a computing device comprising operating system level virtualization. At block 512, the processing device mat execute the first process within the container.

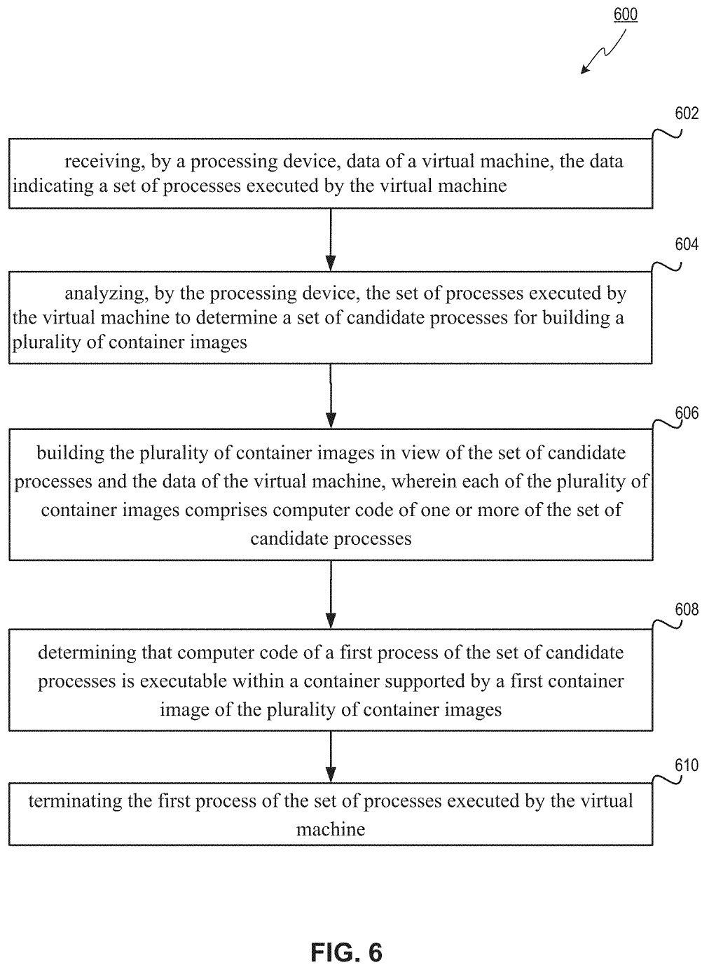

Referring to FIG. 6, method 600 may be performed by processing devices of a server device or a client device and may begin at block 602. At block 602, the processing device may receive data of a virtual machine. The data may indicate a set of processes executed by the virtual machine. The set of processes may include one or more of a web server process, a database process, a filesystem process, a user authentication process, an electronic mail process, other process, or a combination thereof. The data may be associated with or related to data of the guest operating system, running processes, filesystem, other data, or a combination thereof. The data may include operational data that relates to an operational state of the virtual machine and one or more processes or may relate to non-operational data such as virtual machine or guest operating system settings. The data may include persistent data (e.g., non-ephemeral data) or transient data (e.g., ephemeral data), which may correspond to programs while they are being executed and may cease to exist when the programs are shut down.

At block 604, the processing device may analyze the set of processes executed by the virtual machine to determine a set of candidate processes for building a plurality of container images. The processing device may analyze the set of processes in view of a plurality of rules. The plurality of rules may include one or more of: a first rule identifying one or more operating system specific processes and the first rule indicates to exclude the one or more operating system specific processes from the set of candidate processes, a second rule identifying a first process and one or more second processes having interdependency associated with the first process, a third rule identifying one or more third processes to exclude from the set of candidate processes, a fourth rule identifying one or more fourth processes to include in the set of candidate processes, a level of automation for conversion of virtual machine services to containerized services, or other rules related to the set of processes.

At block 606, the processing device may build the plurality of container images in view of the set of candidate processes and the data of the virtual machine. Each of the plurality of container images may include computer code of one or more of the set of candidate processes. Building the plurality of container images may include identifying an order associated with each process of the set of candidate processes indicated in the plurality of rules and building the plurality of container images in view of analyzing the set of candidate processes in the identified order. Building the container image may involve building a plurality of container images that collectively comprise the set of processes executed by the virtual machine. The container image may enable the computer code of the one or more of the set of candidate processes to execute within a container using operating system level virtualization. Building the container image may involve selecting a parent container image in view of the configuration of the virtual machine. The parent container image may include a base image corresponding to a guest operating system of the virtual machine. In one example, the processing device may copy the parent container image from a public repository comprising a plurality of container images and may modify the parent container image to comprise the computer code of the first process. After building the container image, the processing device may store the container image on a storage device accessible over a network. The processing device may also or alternatively register the container image with a repository comprising a plurality of container images. The processing device may or may not initiate execution of the container image on a computing device comprising operating system level virtualization.

At block 608, the processing device may determine that computer code of a first process of the set of candidate processes is executable within a container supported by a first container image of the plurality of container images. The processing device may determine that computer code of a first process of the set of candidate processes is executable within a container supported by a first container image in view of analyzing the first container image in view of a plurality of readiness factors. The plurality of readiness factors may comprise one or more of: equivalency between a particular process within the virtual machine and the particular process within the container, metadata level matching between processes within the virtual machine and the container, file system availability within the container, satisfaction of dependencies between interdependent processes within the container; performance indicator of one or more services executed within the container, or other readiness factors associated with the container images. The processing device may calculate an aggregate score associated with each of the plurality of the container images in view of one or more of the plurality of readiness factors. The processing device may analyze each of the plurality of container images in view of the aggregate score. The processing device may determine that the first container image satisfies at least one of the plurality of readiness factors and route a request for a service to the container supported by the first container image.

At block 610, the processing device may terminate the first process of the set of processes executed by the virtual machine. The processing device may terminate the first process based on determining that the aggregate score associated with the first container image satisfies a first threshold level specified in the system. In addition or alternatively, to terminate the first process executed by the virtual machine, the processing device may obtain a performance score by executing a performance readiness algorithm. The performance readiness algorithm may be executed in view of a plurality of performance indicators associated with a service executed within the container. The processing device may terminate the first process of the set of processes executed by the virtual machine in view of the performance score satisfying a second threshold level specified in the system.

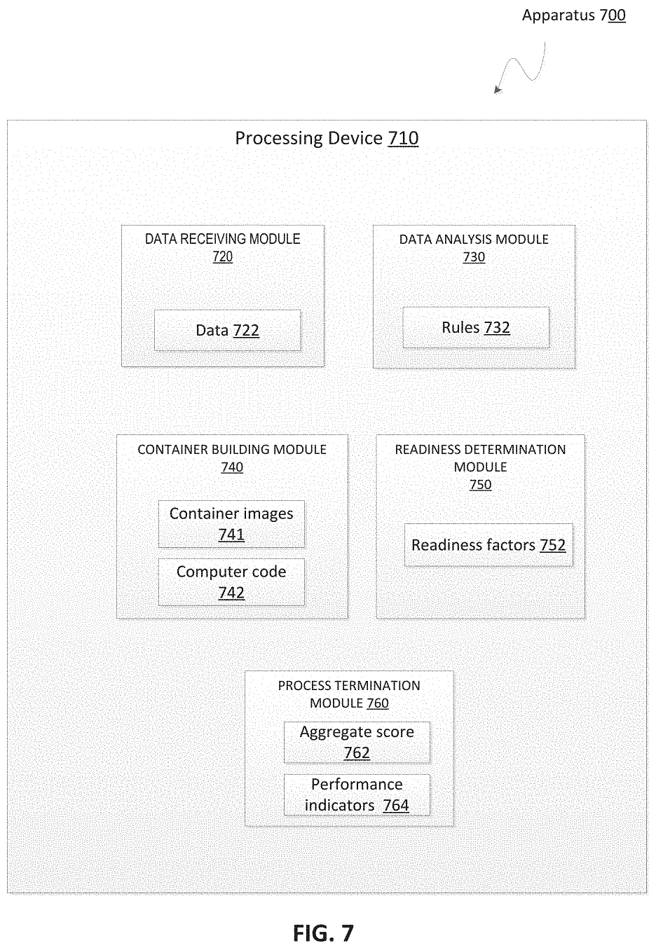

FIG. 7 depicts a block diagram of an example apparatus 700 in accordance with one or more aspects of the present disclosure. The apparatus 400 may correspond to distributed system 100 of FIG. 1. In some implementations, the apparatus 700 may comprise hardware (circuitry, dedicated logic, etc.), software (e.g., software executed by a general purpose computer system or a dedicated machine), or a combination of both. In some implementations, the apparatus 700 may include processing device 710 that may execute instructions for carrying out the operations of the apparatus 700 as discussed herein. As shown, the apparatus 700 may execute instructions for a data receiving module 720, a data analysis module 730, a container building module 740, a readiness determination module 750, and a process termination module 760.

In operations of apparatus 700, data receiving module 720 may receive data 722 of a virtual machine. The data 722 may indicate a set of processes executed by the virtual machine. The set of processes may include one or more of a web server process, a database process, a filesystem process, a user authentication process, an electronic mail process, other process, or a combination thereof. The 722 data may include persistent data (e.g., non-ephemeral data) or transient data (e.g., ephemeral data), which may correspond to programs while they are being executed and may cease to exist when the programs are shut down.

Data analysis module 730 may analyze the set of processes executed by the virtual machine to determine a set of candidate processes for building a plurality of container images. The processing device may analyze the set of processes in view of a plurality of rules 732. The plurality of rules 732 may include one or more of: a first rule identifying one or more operating system specific processes and the first rule indicates to exclude the one or more operating system specific processes from the set of candidate processes, a second rule identifying a first process and one or more second processes having interdependency associated with the first process, a third rule identifying one or more third processes to exclude from the set of candidate processes, a fourth rule identifying one or more fourth processes to include in the set of candidate processes, a level of automation for conversion of virtual machine services to containerized services, or other rules related to the set of processes.

Container building module 740 may build the plurality of container images 741 in view of the set of candidate processes determined by the data analysis module 730 and the data 722 of the virtual machine. Each of the plurality of container images 741 may include computer code 742 of one or more of the set of candidate processes. Building the plurality of container images 741 may include identifying an order associated with each process of the set of candidate processes indicated in the plurality of rules 732 and building the plurality of container images 741 in view of analyzing the set of candidate processes in the identified order. After building the container image, the processing device 710 may store the container image 741 on a storage device accessible over a network.

Readiness determination module 750 may determine that computer code of a first process of the set of candidate processes is executable within a container supported by a first container image of the plurality of container images 741. The determination may be in view of analyzing the first container image in view of a plurality of readiness factors 752. The plurality of readiness factors 752 may comprise one or more of: equivalency between a particular process within the virtual machine and the particular process within the container, metadata level matching between processes within the virtual machine and the container, file system availability within the container, satisfaction of dependencies between interdependent processes within the container; performance indicator of one or more services executed within the container, or other readiness factors associated with the container images. The processing device 710 may calculate an aggregate score associated with each of the plurality of the container images 741 in view of one or more of the plurality of readiness factors 752. The processing device 710 may analyze each of the plurality of container images in view of the aggregate score. The processing device may determine that the first container image satisfies at least one of the plurality of readiness factors 752 and route a request for a service to the container supported by the first container image.

Process termination module 760 may terminate the first process of the set of processes executed by the virtual machine. The processing device may terminate the first process based on determining that the aggregate score 762 associated with the first container image satisfies a first threshold level specified in the system. In addition or alternatively, to terminate the first process executed by the virtual machine, the processing device may obtain a performance score by executing a performance readiness algorithm. The performance readiness algorithm may be executed in view of a plurality of performance indicators 764 associated with a service executed within the container. The processing device 710 may terminate the first process of the set of processes executed by the virtual machine in view of the performance score satisfying a second threshold level specified in the system.

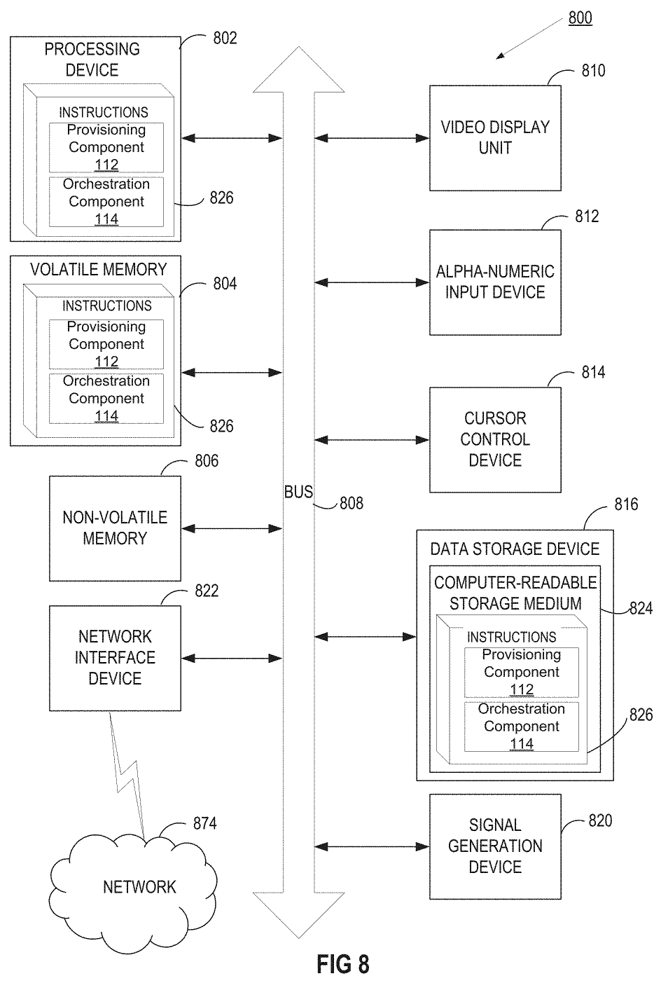

FIG. 8 depicts a block diagram of a computer system operating in accordance with one or more aspects of the present disclosure. In various illustrative examples, computer system 800 may correspond to distributed system 100 of FIG. 1. The computer system may be included within a data center that supports virtualization. Virtualization within a data center results in a physical system being virtualized using virtual machines to consolidate the data center infrastructure and increase operational efficiencies. A virtual machine (VM) may be a program-based emulation of computer hardware. For example, the VM may operate based on computer architecture and functions of computer hardware resources associated with hard disks or other such memory. The VM may emulate a physical computing environment, but requests for a hard disk or memory may be managed by a virtualization layer of a computing device to translate these requests to the underlying physical computing hardware resources. This type of virtualization results in multiple VMs sharing physical resources.

In certain implementations, computer system 800 may be connected (e.g., via a network, such as a Local Area Network (LAN), an intranet, an extranet, or the Internet) to other computer systems. Computer system 800 may operate in the capacity of a server or a client computer in a client-server environment, or as a peer computer in a peer-to-peer or distributed network environment. Computer system 800 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 800 may include a processing device 802, a volatile memory 804 (e.g., random access memory (RAM)), a non-volatile memory 806 (e.g., read-only memory (ROM) or electrically-erasable programmable ROM (EEPROM)), and a data storage device 816, which may communicate with each other via a bus 808.

Processing device 802 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 800 may further include a network interface device 822. Computer system 800 also may include a video display unit 810 (e.g., an LCD), an alphanumeric input device 812 (e.g., a keyboard), a cursor control device 814 (e.g., a mouse), and a signal generation device 820.

Data storage device 816 may include a non-transitory computer-readable storage medium 824 on which may store instructions 826 encoding any one or more of the methods or functions described herein, including instructions for implementing methods 400, 500 or 600 and for encoding provisioning component 112 and orchestration component 114 in FIGS. 1 and 3.

Instructions 826 may also reside, completely or partially, within volatile memory 804 and/or within processing device 802 during execution thereof by computer system 800, hence, volatile memory 804 and processing device 802 may also constitute machine-readable storage media.

While computer-readable storage medium 824 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

Other computer system designs and configurations may also be suitable to implement the system and methods described herein. The following examples illustrate various implementations in accordance with one or more aspects of the present disclosure.

Example 1 is a method comprising: receiving, by a processing device, data of a virtual machine, the data indicating a set of processes executed by the virtual machine; analyzing, by the processing device, the set of processes executed by the virtual machine in view of a plurality of rules; determining, in view of the analysis, a set of candidate processes for building a plurality of container images; and building the plurality of container images in view of the set of candidate processes and the data of the virtual machine.

Example 2 is a method of example 1, wherein each of the plurality of container images comprises computer code of one or more of the set of candidate processes.

Example 3 is a method of example 1, wherein the plurality of rules comprises one or more of: i) a first rule identifying one or more operating system specific processes; ii) a second rule identifying a first process and one or more second processes having interdependency associated with the first process; iii) a third rule identifying one or more third processes to exclude from the set of candidate processes; or iv) a fourth rule identifying one or more fourth processes to include in the set of candidate processes.

Example 4 is a method of example 1, wherein the first rule indicates to exclude the one or more operating system specific processes from the set of candidate processes.

Example 5 is a method of example 1, wherein building the plurality of container images comprises: identifying an order associated with each process of the set of candidate processes indicated in the plurality of rules; and building the plurality of container images in view of analyzing the set of candidate processes in the identified order.

Example 6 is a method of example 1, further comprising: storing the plurality of container images on a storage device; registering the plurality of container images with a repository of container images; and initiating the execution of one or more of the plurality of container images on a computing device comprising operating system level virtualization.

Example 7 is a method of example 1, further comprising: initiating, by the processing device of a first computing device, installation of an agent on a second computing device comprising the virtual machine; and receiving, by the processing device of the first computing device, the data from the agent, wherein the first computing device and the second computing device are separated by a computer network.

Example 8 is system comprising: a memory; a processing device operatively coupled to the memory, the processing device to: store a plurality of container images on a storage device, each of the plurality of container images stored on the storage device comprising computer code of one or more of a set of processes executed by a virtual machine; analyze each of the plurality of the container images stored on the storage device in view of a plurality of readiness factors; determine that computer code of a first process of the set of processes is executable within a container supported by a first container image of the plurality of container images; terminate the first process of the set of processes executed by the virtual machine; instantiate the container using the first container image; and execute the first process within the container.

Example 9 is a system of example 8, wherein the plurality of readiness factors comprises one or more of: i) equivalency between a particular process within the virtual machine and the particular process within the container; ii) metadata level matching between processes within the virtual machine and the container; iii) file system availability within the container; iv) satisfaction of dependencies between interdependent processes within the container; or v) performance indicator of one or more services executed within the container.

Example 10 is a system of example 8, wherein to analyze each of the plurality of the container images stored on the storage device in view of a plurality of readiness factors, the processing device is to: calculate an aggregate score associated with each of the plurality of the container images in view of one or more of the plurality of readiness factors; and analyze each of the plurality of container images in view of the aggregate score.

Example 11 is a system of example 10, wherein the processing device is further to:

prior to terminating the first process, determine that the aggregate score associated with the first container image satisfies a first threshold level specified in the system.

Example 12 is a system of example 8, wherein to terminate the first process executed by the virtual machine, the processing device is to: obtain a performance score by executing a performance readiness algorithm in view of a plurality of performance indicators associated with a service executed within the container; and terminate the first process of the set of processes executed by the virtual machine in view of the performance score satisfying a second threshold level specified in the system.

Example 13 is a system of example 8, wherein the processing device is further to: determine that the first container image satisfies at least one of the plurality of readiness factors; and in response to the determination that the first container image satisfies at least one of the plurality of readiness factors, route a request for a particular service to the container supported by the first container image.

Example 14 is a system of example 8, wherein to instantiate the container using the first container image, the processing device is to: initiate the execution of the first container image on a computing device comprising operating system level virtualization.

Example 15 is a non-transitory computer-readable medium comprising instructions that, when executed by a processing device of a first computer system, cause the processing device to perform operations comprising: receiving data of a virtual machine, the data indicating a set of processes executed by the virtual machine; analyzing the set of processes executed by the virtual machine to determine a set of candidate processes for building a plurality of container images; building the plurality of container images in view of the set of candidate processes and the data of the virtual machine, wherein each of the plurality of container images comprises computer code of one or more of the set of candidate processes; determining that computer code of a first process of the set of candidate processes is executable within a container supported by a first container image of the plurality of container images; and terminating the first process of the set of processes executed by the virtual machine.

Example 16 is a non-transitory computer-readable medium of example 15, wherein analyzing set of processes executed by the virtual machine comprises: analyzing set of processes in view of a plurality of rules comprising one or more of: i) a first rule identifying one or more operating system specific processes; ii) a second rule identifying a first process and one or more second processes having interdependency associated with the first process; iii) a third rule identifying one or more third processes to exclude from the set of candidate processes; or iv) a fourth rule identifying one or more fourth processes to include in the set of candidate processes.

Example 17 is a non-transitory computer-readable medium of example 15, wherein building the plurality of container images comprises: identifying an order associated with each process of the set of candidate processes indicated in the plurality of rules; and building the plurality of container images in view of analyzing the set of candidate processes in the identified order.

Example 18 is a non-transitory computer-readable medium of example 15, wherein the processing device is to perform further operations comprising: storing the plurality of container images on a storage device; registering the plurality of container images with a repository of container images; and initiating the execution of one or more of the plurality of container images on a computing device comprising operating system level virtualization.

Example 19 is a non-transitory computer-readable medium of example 15, wherein determining that computer code of a first process of the set of candidate processes is executable within a container supported by a first container image comprises: determining that computer code of a first process of the set of candidate processes is executable within a container supported by a first container image in view of analyzing the first container image in view of a plurality of readiness factors comprising one or more of: i) equivalency between a particular process within the virtual machine and the particular process within the container; ii) metadata level matching between processes within the virtual machine and the container; iii) file system availability within the container; iv) satisfaction of dependencies between interdependent processes within the container; or v) performance indicator of one or more services executed within the container.

Example 20 is a non-transitory computer-readable medium of example 15, wherein the processing device is to perform further operations comprising: determining that the first container image satisfies at least one of the plurality of readiness factors; and in response to determining that the first container image satisfies at least one of the plurality of readiness factors, route a request for a particular service to the container supported by the first container image.

Example 21 is a system comprising: a memory; a processing device operatively coupled to the memory, the processing device to: build a plurality of container images in view of data of a virtual machine, wherein each of the plurality of container images comprises computer code of one or more of a set of processes executed by the virtual machine; store the plurality of container images on a storage device; analyze each of the plurality of the container images stored on the storage device in view of a plurality of readiness factors; determine, in view of the analysis, that a first container image of the plurality of container images satisfies at least one of the plurality of readiness factors; identify a first process of the set of processes to be executed within a container supported by the first container image; and terminate the first process of the set of processes executed by the virtual machine.

Example 22 is a system of example 21, wherein the plurality of readiness factors comprises one or more of: i) equivalency between a particular process within the virtual machine and the particular process within the container; ii) metadata level matching between processes within the virtual machine and the container; iii) file system availability within the container; iv) satisfaction of dependencies between interdependent processes within the container; or v) performance indicator of one or more services executed within the container.

Example 23 is a system of example 21, wherein to analyze each of the plurality of the container images stored on the storage device in view of a plurality of readiness factors, the processing device is to: calculate an aggregate score associated with each of the plurality of the container images in view of one or more of the plurality of readiness factors; and analyze each of the plurality of container images in view of the aggregate score.

Example 24 is a system of example 21, wherein the processing device is further to:

prior to terminating the first process, determine that the aggregate score associated with the first container image satisfies a first threshold level specified in the system.

Example 25 is a system of example 21, wherein to terminate the first process executed by the virtual machine, the processing device is to: obtain a performance score by executing a performance readiness algorithm in view of a plurality of performance indicators associated with a service executed within the container; and terminate the first process of the set of processes executed by the virtual machine in view of the performance score satisfying a second threshold level specified in the system.

Example 26 is a system of example 21, wherein the processing device is further to: determine that the first container image satisfies at least one of the plurality of readiness factors; and in response to the determination that the first container image satisfies at least one of the plurality of readiness factors, route a request for a particular service to the container supported by the first container image.

Example 27 is a system of example 21, wherein the processing device is further to: instantiate the container using the first container image; and execute the first process within the container.

Example 28 is a system of example 27, wherein to instantiate the container using the first container image, the processing device is to: initiate the execution of the first container image on a computing device comprising operating system level virtualization.

Example 29 is a system of example 27, wherein the processing device is further to: initiate installation of an agent on a computing device comprising the virtual machine; and receive the data of the virtual machine from the agent.

Example 30 is an apparatus comprising: a means for receiving data of a virtual machine, the data indicating a set of processes executed by the virtual machine; a means for analyzing the set of processes executed by the virtual machine to determine a set of candidate processes for building a plurality of container images; a means for building the plurality of container images in view of the set of candidate processes and the data of the virtual machine, wherein each of the plurality of container images comprises computer code of one or more of the set of candidate processes; a means for determining that computer code of a first process of the set of candidate processes is executable within a container supported by a first container image of the plurality of container images; and a means for terminating the first process of the set of processes executed by the virtual machine.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “determining,” “detecting,” “analyzing,” “selecting,” “building,” “classifying,” “updating,” “optimizing” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform methods 400, 500, 600 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method comprising:
receiving, by a processing device, data of a virtual machine, the data indicating a set of processes executed by the virtual machine;
analyzing, by the processing device, the set of processes executed by the virtual machine in view of a plurality of rules comprising a first rule defining interdependencies between processes in the set of processes executed by the virtual machine;
determining, in view of the analysis, a set of candidate processes for building a plurality of container images; and
building the plurality of container images in view of the set of candidate processes and the data of the virtual machine.

2. The method of claim 1, wherein each of the plurality of container images comprises computer code of one or more of the set of candidate processes.

3. The method of claim 1, wherein the plurality of rules further comprises one or more of:
i) a second rule identifying one or more operating system specific processes;
ii) a third rule identifying one or more third processes to exclude from the set of candidate processes; or
iii) a fourth rule identifying one or more fourth processes to include in the set of candidate processes.

4. The method of claim 1, wherein the second rule indicates to exclude the one or more operating system specific processes from the set of candidate processes.

5. The method of claim 1, wherein building the plurality of container images comprises:
identifying an order associated with each process of the set of candidate processes indicated in the plurality of rules; and
building the plurality of container images in view of analyzing the set of candidate processes in the identified order.

6. The method of claim 1, further comprising:
storing the plurality of container images on a storage device;
registering the plurality of container images with a repository of container images; and
initiating the execution of one or more of the plurality of container images on a computing device comprising operating system level virtualization.

7. The method of claim 1, further comprising:
initiating, by the processing device of a first computing device, installation of an agent on a second computing device comprising the virtual machine; and
receiving, by the processing device of the first computing device, the data from the agent, wherein the first computing device and the second computing device are separated by a computer network.

8. A system comprising:
a memory;
a processing device operatively coupled to the memory, the processing device to:
store a plurality of container images on a storage device, each of the plurality of container images stored on the storage device comprising computer code of one or more of a set of processes executed by a virtual machine;
analyze each of the plurality of the container images stored on the storage device in view of a plurality of readiness factors;
determine that computer code of a first process of the set of processes is executable within a container supported by a first container image of the plurality of container images;
terminate the first process of the set of processes executed by the virtual machine;
instantiate the container using the first container image; and
execute the first process within the container.

9. The system of claim 8, wherein the plurality of readiness factors comprises one or more of:
i) equivalency between a particular process within the virtual machine and the particular process within the container;
ii) metadata level matching between processes within the virtual machine and the container;
iii) file system availability within the container;
iv) satisfaction of dependencies between interdependent processes within the container; or
v) performance indicator of one or more services executed within the container.

10. The system of claim 8, wherein to analyze each of the plurality of the container images stored on the storage device in view of a plurality of readiness factors, the processing device is to:
calculate an aggregate score associated with each of the plurality of the container images in view of one or more of the plurality of readiness factors; and
analyze each of the plurality of container images in view of the aggregate score.

11. The system of claim 10, wherein the processing device is further to:
prior to terminating the first process, determine that the aggregate score associated with the first container image satisfies a first threshold level specified in the system.

12. The system of claim 8, wherein to terminate the first process executed by the virtual machine, the processing device is to:
obtain a performance score by executing a performance readiness algorithm in view of a plurality of performance indicators associated with a service executed within the container; and
terminate the first process of the set of processes executed by the virtual machine in view of the performance score satisfying a second threshold level specified in the system.

13. The system of claim 8, wherein the processing device is further to:
determine that the first container image satisfies at least one of the plurality of readiness factors; and
in response to the determination that the first container image satisfies at least one of the plurality of readiness factors, route a request for a particular service to the container supported by the first container image.

14. The system of claim 8, wherein to instantiate the container using the first container image, the processing device is to:
initiate the execution of the first container image on a computing device comprising operating system level virtualization.

15. A non-transitory computer-readable medium comprising instructions that, when executed by a processing device of a first computer system, cause the processing device to perform operations comprising:
receiving data of a virtual machine, the data indicating a set of processes executed by the virtual machine;
analyzing the set of processes executed by the virtual machine to determine a set of candidate processes for building a plurality of container images;
building the plurality of container images in view of the set of candidate processes and the data of the virtual machine, wherein each of the plurality of container images comprises computer code of one or more of the set of candidate processes;
determining that computer code of a first process of the set of candidate processes is executable within a container supported by a first container image of the plurality of container images; and
terminating the first process of the set of processes executed by the virtual machine.

16. The non-transitory computer-readable medium of claim 15, wherein analyzing set of processes executed by the virtual machine comprises:
analyzing set of processes in view of a plurality of rules comprising one or more of:
i) a first rule identifying one or more operating system specific processes;
ii) a second rule identifying a first process and one or more second processes having interdependency associated with the first process;
iii) a third rule identifying one or more third processes to exclude from the set of candidate processes; or
iv) a fourth rule identifying one or more fourth processes to include in the set of candidate processes.

17. The non-transitory computer-readable medium of claim 15, wherein building the plurality of container images comprises:
identifying an order associated with each process of the set of candidate processes indicated in the plurality of rules; and
building the plurality of container images in view of analyzing the set of candidate processes in the identified order.

18. The non-transitory computer-readable medium of claim 15, wherein the processing device is to perform further operations comprising:
storing the plurality of container images on a storage device;
registering the plurality of container images with a repository of container images; and
initiating the execution of one or more of the plurality of container images on a computing device comprising operating system level virtualization.

19. The non-transitory computer-readable medium of claim 15, wherein determining that computer code of a first process of the set of candidate processes is executable within a container supported by a first container image comprises:
determining that computer code of a first process of the set of candidate processes is executable within a container supported by a first container image in view of analyzing the first container image in view of a plurality of readiness factors comprising one or more of:
i) equivalency between a particular process within the virtual machine and the particular process within the container;
ii) metadata level matching between processes within the virtual machine and the container;
iii) file system availability within the container;
iv) satisfaction of dependencies between interdependent processes within the container; or
v) performance indicator of one or more services executed within the container.

20. The non-transitory computer-readable medium of claim 15, wherein the processing device is to perform further operations comprising:
determining that the first container image satisfies at least one of the plurality of readiness factors; and
in response to determining that the first container image satisfies at least one of the plurality of readiness factors, route a request for a particular service to the container supported by the first container image.
